(19) United States
(12) Patent Application Publication
(10) Pub. No.: US 2021/0345541 A1
(43) Pub. Date: Nov. 11, 2021

(54) FLEXIBLE GREENING SYSTEM INTEGRATED WITH WATER INTO FERTILIZER

(71) Applicant: Nanjing Hydraulic Research Institute, Nanjing (CN)

(72) Inventors: Xiaojun WANG, Nanjing (CN); Feng CHEN, Nanjing (CN); Jianyun ZHANG, Nanjing (CN)

(21) Appl. No.: 17/382,710

(22) Filed: Jul. 22, 2021

(30) Foreign Application Priority Data
Nov. 26, 2020 (CN) 202011349712.6

(51) Int. Cl. A01C 23/04; A01C 23/00; A01G 9/02; A01G 27/00; E02B 11/00; A01G 24/46

(52) U.S. Cl. CPC A01C 23/047; A01C 23/007; A01G 9/025; A01G 24/46; A01G 27/008; E02B 11/005; A01G 27/003

(57) ABSTRACT

A flexible greening system integrated with water into fertilizer includes a vegetation fixing assembly, a vegetation growth layer and a water supply assembly. The vegetation fixing assembly is configured to connect to a building. The vegetation growth layer is provided on the vegetation fixing assembly and is configured for planting of green vegetation. The vegetation growth layer includes a substrate layer for vegetation growth and a drainage layer provided below the substrate layer. The water supply assembly is configured to supply the water to the green vegetation, and is provided with a drainage pipe communicated with the drainage layer.

### CROSS-REFERENCE TO RELATED APPLICATIONS

This application claims the benefit of priority from Chinese Patent Application No. 202011349712.6, filed on Nov. 26, 2020. The content of the aforementioned application, including any intervening amendments thereto, is incorporated herein by reference in its entirety.

### TECHNICAL FIELD

This application relates to development and comprehensive utilization of water resources, and more particularly to a flexible greening system integrated with water into fertilizer.

### BACKGROUND

In recent years, the continuous acceleration of the urbanization process has caused an increasingly serious eco-environmental problem. At the same time, the greening degree has also changed significantly with the expansion of built-up urban areas and population growth. Considering the limited urban space, the plane greening fails to meet the needs of urban greening. Vertical greening is considered as an important supplement to the plane greening due to less space occupation and high efficiency, which can effectively alleviate the shortage of urban greening land. Therefore, the vertical greening with integration of buildings and plants has attracted more and more attention as a new greening method.

With respect to the existing vertical greening technology, the plants grow in a relatively harsh environment in which the water is not easy to store. Moreover, strong wind and intense radiation can easily cause water shortage or death of the plants. In addition, the existing vertical greening requires more irrigation water, causing higher water consumption and irrigation cost.

### SUMMARY

An object of this application is to provide a flexible greening system integrated with water into fertilizer to overcome the defects of large water consumption and high irrigation cost in the existing vertical greening system.

Technical solutions of this disclosure are described as follows.

This application provides a flexible greening system integrated with water into fertilizer, comprising:

a vegetation fixing assembly;

a vegetation growth layer; and

a water supply assembly;

wherein the vegetation fixing assembly is configured to connect to a building or to support the flexible greening system; the vegetation growth layer is provided on the vegetation fixing assembly and is configured to for planting of green vegetation; the vegetation growth layer comprises a substrate layer for vegetation growth and a drainage layer provided below the substrate layer; the water supply assembly is configured to supply water to the green vegetation; and the water supply assembly is provided with a drainage pipe communicated with the drainage layer.

In an embodiment, the vegetation fixing assembly comprises a fixing frame base layer and a covering layer; the fixing frame base layer is configured to connect with the building; the fixing frame base layer is provided with an accommodating groove configured to accommodate the vegetation growth layer; the fixing frame base is suitable for a slope with a sloping degree of 0-360°; the fixing frame base layer is made of a flexible material; the covering layer is connected to the fixing frame base layer and is configured to cover the accommodating groove; the covering layer is provided with a stem-locking component; and the stem-locking component is configured to enable the green vegetation to pass through and is always matched with a stem of the green vegetation. Different flexible materials vary in the flexibility index, for example, winding a Φ20-25 mm round rod without cracks; tensile strength greater than or equal to 80%; and ultimate elongation greater than or equal to 70%.

In an embodiment, the stem-locking component comprises a water-containing ring; the water-containing ring is made of a flexible material and is connected to the covering layer; and the water-containing ring is provided with a water storage cavity communicated with the water supply assembly.

In an embodiment, the water-containing ring is communicated with the drainage pipe.

In an embodiment, the water supply assembly comprises a water supply pipe and a power pump; the water supply pipe is communicated with a water source for supplying water to the substrate layer; the water supply pipe is communicated with the drainage pipe; and the power pump is communicated with the water supply pipe.

In an embodiment, the water supply pipe is provided with a water supply branch pipe configured to be inserted into the vegetation growth layer; the water supply pipe is provided with a control valve; and the control valve is configured to control whether water flows into the water supply branch pipe.

In an embodiment, the water supply assembly further comprises a fertilizer tank, a monitoring and control device for monitoring and control of watering and fertilizing and a hydrodynamic fertilizer pump; the fertilizer tank is configured to store a liquid fertilizer; one end of the hydrodynamic fertilizer pump is communicated with the fertilizer tank; and the other end of the hydrodynamic fertilizer pump is communicated with the water supply pipe.

In an embodiment, the flexible greening system further comprises a fixing net; wherein the fixing net is configured to cover the vegetation growth layer and the green vegetation. The fixing net is always matched with branches of the green vegetation and can be designed into different shapes according to needs of space greening.

In an embodiment, the flexible greening system further comprising an intelligent monitoring assembly; wherein the intelligent monitoring assembly comprises a humidity sensor, a vegetation growth sensor, a precipitation sensor and a controller; the humidity sensor is provided in the vegetation growth layer and is configured to monitor a relative humidity in the vegetation growth layer; the vegetation growth sensor is provided on the green vegetation and is configured to monitor a growth state of the green vegetation; the precipitation sensor is connected to the vegetation fixing assembly or the building and is configured to monitor an external weather condition; and the controller is electrically connected to the humidity sensor, the vegetation growth sensor, the precipitation sensor and the water supply assembly.

It has been found that most of the existing vertical greening systems comprise a plurality of base modules for growing green plants, a drip irrigation pipe and a mounting frame. The drip irrigation pipe is provided above the vertical greening system, and the external water flows freely in the base modules through the drip irrigation pipe. The mounting frame is configured to fix the base modules and the drip irrigation pipe on a wall of the building. However, insufficient and uneven water supply will occur during the operation of the vertical greening system. In addition, the existing vertical greening system is fixedly mounted, causing relatively high transportation and maintenance costs.

Compared to the prior art, this disclosure has the following beneficial effects.

With respect to the flexible greening system integrated with water into fertilizer, the water in the water supply assembly provides water for the survival of the green vegetation planted on the substrate layer. The excess water will flow into the drainage pipe through the drainage layer to be recycled, which effectively reduces the irrigation water consumption and saves irrigation costs. At the same time, the fertilizer nutrients needed for plant growth can also enter the greening system through the water supply assembly.

### BRIEF DESCRIPTION OF THE DRAWINGS

Technical solutions of the present disclosure will be obvious from the following description in conjunction with the embodiments. It is apparent that presented in the drawings are only some embodiments of the present disclosure. Those of ordinary skill in the art can also obtain other drawings based on these drawings without paying creative efforts.

FIG. 1 schematically shows a three-dimensional structure of a flexible greening system integrated with water into fertilizer according to an embodiment of the present disclosure.

FIG. 2 schematically shows a three-dimensional structure of a covering layer in the flexible greening system according to an embodiment of the present disclosure.

FIG. 3 schematically shows the covering layer shown in FIG. 2 in use.

FIG. 4 is a sectional view of the covering layer shown in FIG. 2 along A-A.

FIG. 5 is a schematic diagram of a vegetation growth layer in the flexible greening system according to an embodiment of the present disclosure.

FIG. 6 is a schematic diagram of a flexible greening system integrated with water into fertilizer according to another embodiment of the present disclosure.

FIG. 7 is another schematic diagram of the flexible greening system according to another embodiment of the present disclosure.

FIG. 8 is another schematic diagram of the flexible greening system according to another embodiment of the present disclosure.

FIG. 9 is a frame diagram of an intelligent monitoring assembly in the flexible greening system according to an embodiment of the present disclosure.

FIG. 10 is a frame diagram of a water supply assembly in the flexible greening system according to an embodiment of the present disclosure.

FIG. 11 shows a connection between a fixing net and a vegetation fixing assembly in the flexible greening system according to an embodiment of the present disclosure.

In this drawings: 1, vegetation fixing assembly; 11, fixing frame base layer; 111, accommodating groove; 12, covering layer; 121, stem-locking component; 2, vegetation growth layer; 21, substrate layer; 22, drainage layer; 23, root puncture-resistant layer; 24, waterproof layer; 3, water supply assembly; 31, drainage pipe; 32, water supply pipe; 321, water supply branch pipe; 322, ventilation pipe; 33, power pump; 34, rainwater collection assembly; 35, control valve; 36, fertilizer tank; 37, monitoring and control device for monitoring and control of watering and fertilizing; 38, hydrodynamic fertilizer pump; 4, intelligent monitoring assembly; 41, humidity sensor; 42, precipitation sensor; 43, controller; and 5, fixing net.

### DETAILED DESCRIPTION OF EMBODIMENTS

The present disclosure will be further described in detail with reference to the embodiments and the accompanying drawings to make technical solutions, features, objectives and advantages of the present disclosure better understood. It should be understood that the embodiments are only illustrative, and are not intended to limit the scope of the application.

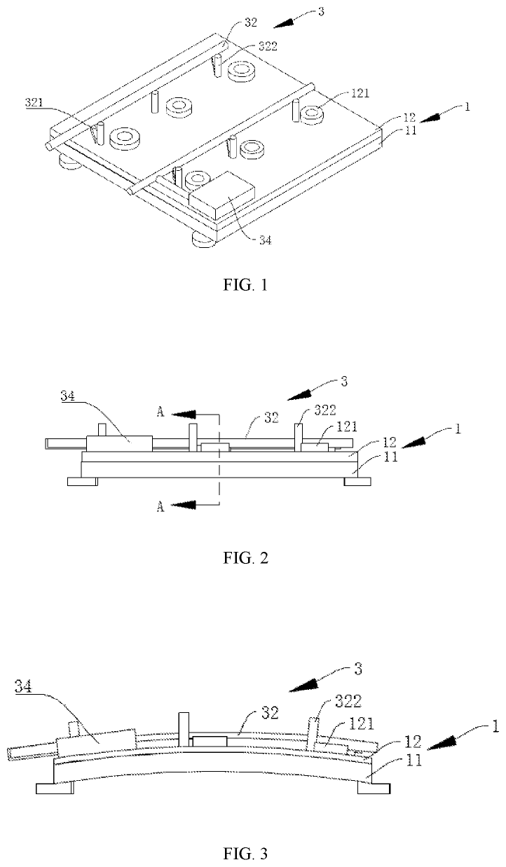

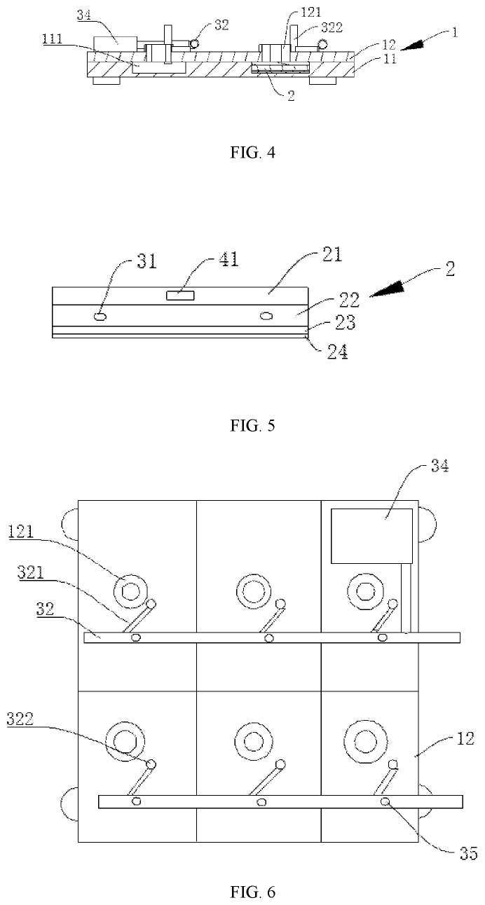

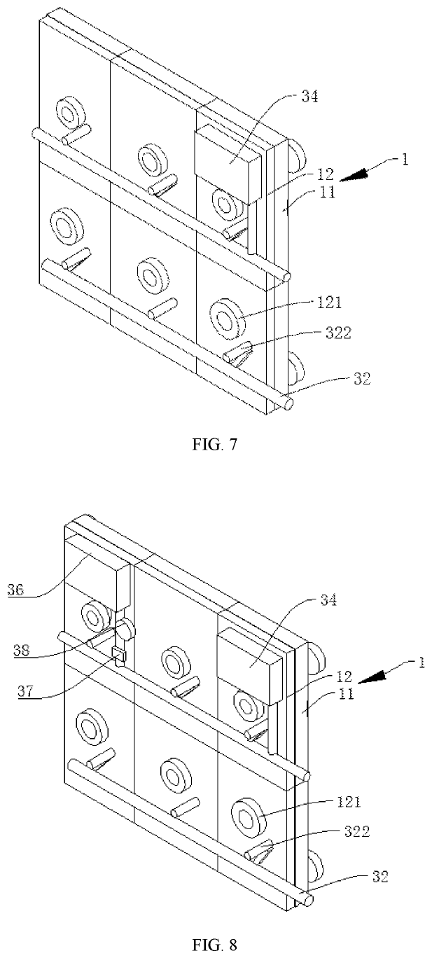

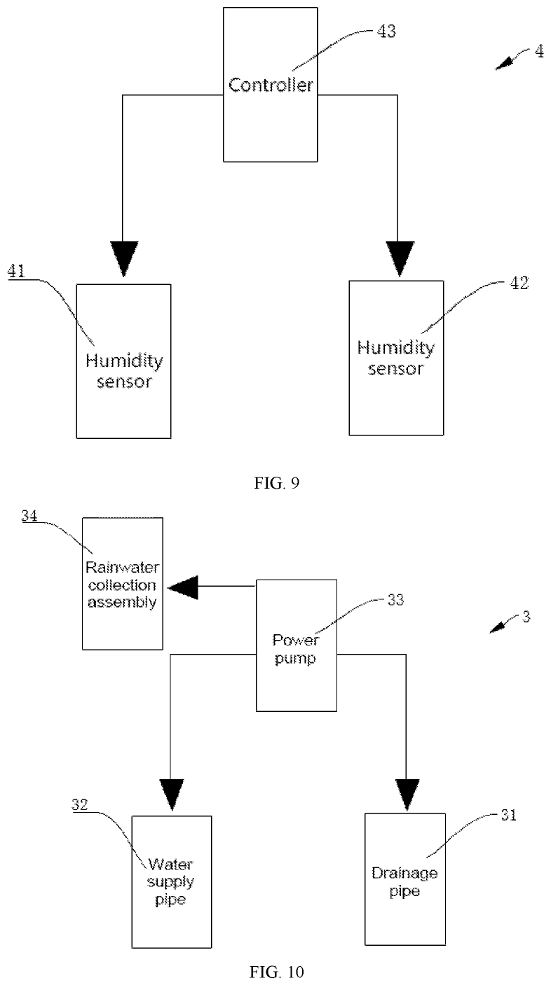

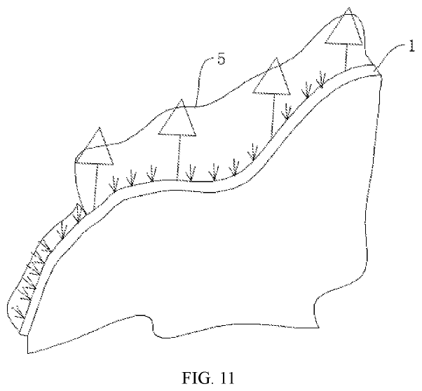

Referring to an embodiment shown in FIGS. 1-11, provided is a flexible greening system integrated with water into fertilizer, including a vegetation fixing assembly 1, a vegetation growth layer 2 and a water supply assembly 3. The vegetation fixing assembly 1 is configured to connect to a building. The vegetation growth layer 2 is provided on the vegetation fixing assembly 1 and is configured for planting of green vegetation. The vegetation growth layer 2 includes a substrate layer 21 for vegetation growth and a drainage layer 22 provided below the substrate layer 21. The water supply assembly 3 is configured to supply water to the green vegetation. The water supply assembly 3 is provided with a drainage pipe 31 communicated with the drainage layer 22.

When the water supply assembly 3 supplies water to the green vegetation, the excess water penetrates the substrate layer 21 into the drainage layer 22 followed by flowing into the drainage pipe 31 to be recycled.

With respect to the flexible greening system, the water in the water supply assembly 3 provides water for the survival of the green vegetation planted on the substrate layer 21. The excess water will flow into the drainage pipe 31 through the drainage layer 22 to be recycled, which effectively reduces the irrigation water consumption and save irrigation costs. At the same time, the fertilizer nutrients needed for plant growth can also enter the greening system through the water supply assembly.

In this embodiment, the drainage layer 22 includes a structural layer made of glass pumice.

In this embodiment, the vegetation growth layer 2 also includes a root puncture-resistant layer 23 provided on a lower layer of the drainage layer 22 and a waterproof layer 24 provided on a lower layer of the root puncture-resistant layer 23.

Referring to an embodiment shown in FIGS. 1-3, the vegetation fixing assembly 1 includes a fixing frame base layer 11 and a covering layer 12. The fixing frame base layer 11 is configured to connect with the building. The fixing frame base layer 11 is provided with an accommodating groove 111. The accommodating groove 111 is configured to accommodate the vegetation growth layer 2. The covering layer 12 is connected to the fixing frame base layer 11 and is configured to cover the accommodating groove 111. The covering layer 12 is provided with a stem-locking component 121. The stem-locking component 121 is configured to enable the green vegetation to pass through and is always matched with a stalk of the green vegetation.

The covering layer 12 is configured to cover the accommodating groove 111, avoiding the separation of the vegetation growth layer 2 and the vegetation fixing assembly 1 and improving the safety of the flexible greening system integrated with water into fertilizer in the building. In addition, the vegetation growth layer 2 is prevented from being directly irradiated by the sun, and the water loss in the vegetation growth layer 2 is reduced. The stem-locking component 121 is matched with the stalk of the green vegetation, which ensures the tightness between the stem-locking component 121 and the green vegetation without a gap, thereby further reducing the water loss in the vegetation growth layer 2.

In this embodiment, the flexible greening system integrated with water into fertilizer is an overlying greening system that is overlain on a surface of the building. The flexible greening system integrated with water into fertilizer is suitable for a slope with a sloping degree of 0-360°. The flexible greening system integrated with water into fertilizer has a certain degree of flexibility to allow it to adapt to an arc-shaped underlayer and to be easily mounted and disassembled. The fixing frame base layer 11 can be bent to different degrees as required.

In this embodiment, the fixing frame base layer 11 is made of a corrosion-resistant and anti-aging rubber material. The fixing frame base layer 11 is provided with a connecting assembly for connecting to the building. The connecting assembly includes a buckle and a bolt. The connecting assembly can be of any structure as long as the connecting assembly allows the fixing frame base layer 11 to be fixed on the building. Specifically, a side of the fixing frame base layer 11 close to the building is provided with a key point for fixation, and the buckle is provided around the key point for splicing.

In this embodiment, the fixing frame base layer 11 can be formed by splicing a plurality of small frames through the buckle and the bolt. Each of the plurality of small frames is provided with accommodating groove 111. A shape and a size of the fixing frame base layer 11 can be specified. It should be noted that at this time, the covering layer 12 is composed of a plurality of small covering layers, and the plurality of small covering layers are in one-to-one correspondence to the plurality of small frames.

The flexible greening system integrated with water into fertilizer is applicable to the greening of different scenes and has a wider range.

In this embodiment, the covering layer 12 is provided with a sealing ring for sealed connection with a notch of the accommodating groove 111, so as to further improve the leak-proofness when the covering layer 12 covers the accommodating groove 111.

In this embodiment, the stem-locking component 121 includes a spring structure and/or a buffer structure. The stem-locking component 121 is not specifically limited herein in the structure as long as the stem-locking component 121 can be connected to the covering layer 12. The stem-locking component 121 is provided with a ring structure for contacting with the stalk of the green vegetation, which can produce corresponding deformations with changes in the diameter of the stalk of the green vegetation.

In this embodiment, the stem-locking component 121 is in one-to-one correspondence to the accommodating groove 111.

Referring to an embodiment shown in FIGS. 1-8, the stem-locking component 121 includes a water-containing ring, which is made of a flexible material and is connected to the covering layer 12. The water-containing ring is provided with a water storage cavity communicated with the water supply assembly 3. The water supply assembly 3 supplies the water to the water-containing ring to enable the water-containing ring to contact with the stalk of the green vegetation. In addition, the water supply assembly 3 can adjust the amount of the water introduced into the water-containing ring to adapt to the increase of the stalk of the green vegetation. The stem-locking component 121 has a simple structure and low production cost, which is conducive to large-scale popularization and application. The water-containing ring also has a cooling effect on the accommodating groove 111.

In this embodiment, the water-containing ring is provided with a nozzle. The nozzle is provided in the accommodating groove 111 and is communicated with the water storage cavity. The nozzle is provided with an electric valve structure. The water-containing ring has a water storage function, such that when the water supply assembly 3 fails to supply the water to the vegetation growth layer 2, the water stored in the water-containing ring is allowed to flow into the vegetation growth layer 2 to supply the water in time by controlling the electric valve structure.

Referring to an embodiment shown in FIGS. 1-11, the water-containing ring is communicated with the drainage pipe 31. When there is excessive water in the water-containing ring, the water directly flows into the drainage pipe 31 or sequentially passes through the substrate layer 21 and the drainage layer 22 into the drainage pipe 31, which prevents the water-containing ring from being damaged by excessive water, thereby improving the service life of the water-containing ring. At the same time, the fluidity of the water in the water-containing ring is increased, which adjusts the temperature in the accommodating groove 111 to a certain extent.

In this embodiment, the water-containing ring is provided with a thermal insulation layer to ensure the normal operation of the water-containing ring in a low-temperature area, so as to improve the application scope of the greening system in the building.

Referring to an embodiment shown in FIGS. 1-11, the water supply assembly 3 includes a water supply pipe 32 and a power pump 33. The water supply pipe 32 is communicated with a water source for supplying water to the substrate layer 21. The water supply pipe 32 is communicated with the drainage pipe 31. The power pump 33 is communicated with the water supply pipe 32. The water flowing into the drainage pipe 31 automatically flows into the water supply pipe 32, which avoids waste of the water resource and reduces the amount of water drawn by the power pump 33 from the water source, thereby reducing the irrigation cost.

In this embodiment, the water supply pipe 32 is communicated with the water storage cavity in the water-containing ring through a pipeline.

In this embodiment, the water supply assembly 3 further includes a fertilizer tank 36 and a hydrodynamic fertilizer pump 38. The fertilizer tank 36 is configured to store a liquid fertilizer. One end of the hydrodynamic fertilizer pump 38 is communicated with the fertilizer tank, and the other end of the hydrodynamic fertilizer pump 38 is communicated with the water supply pipe 32. The kinetic energy generated by the water in the water supply pipe 32 drives the hydrodynamic fertilizer pump 38 to work, such that the hydrodynamic fertilizer pump 38 quantitatively sucks a medicament in the fertilizer tank 36 to enable the medicament to be mixed with the water. The medicament and the fertilizer are mixed in a volume proportion in the hydrodynamic fertilizer pump 38 according to the needs of the green vegetation, which has nothing to do with the change of water pressure and water volume in the pipeline, realizing the direct proportional mixing and feeding. The fertilizer and its dosage are determined according to the growth status of the green vegetation, and then the fertilizer and the water are directly supplied to the growth layer of plant roots through the pipeline.

In this embodiment, the water supply assembly 3 further includes a monitoring and control device 37 for monitoring and control of watering and fertilizing. The monitoring and control device 37 for monitoring and control of watering and fertilizing is connected to the pipeline between the fertilizer tank 36 and the hydrodynamic fertilizer pump 38. The monitoring and control device 37 for monitoring and control of watering and fertilizing is configured to monitor the temperature and concentration of the fertilizer in the fertilizer tank 36, the hydrodynamic fertilizer pump 38 and the pipeline therebetween. In addition, the monitoring and control device 37 for monitoring and control of watering and fertilizing is configured to control the concentration and amount of the fertilizer through a regulating valve. Specifically, the monitoring and control device 37 for monitoring and control of watering and fertilizing includes a temperature sensor, a concentration sensor and the regulating valve, which are provided on the fertilizer tank 36, the hydrodynamic fertilizer pump 38 and the pipeline therebetween.

Referring to an embodiment shown in FIGS. 1-8, the water supply pipe 32 is provided with a water supply branch pipe 321 configured to be inserted into the vegetation growth layer 2. The water supply pipe 32 is provided with a control valve 35. The control valve 35 is configured to control whether water flows into the water supply branch pipe 321. The control valve 35 is controlled, such that the opening and closing of the water supply branch pipe 321 are controlled. Such structure improves the accuracy of irrigation with the water in the water supply pipe 32 and ensures that the flexible greening system can timely and efficiently irrigate the green vegetation at different locations.

In this embodiment, the water supply branch pipe 321 uses drip irrigation technology and micro-sprinkler irrigation technology.

In this embodiment, the water supply branch pipe 321 has the same amount as the accommodating groove 111.

In this embodiment, the water supply branch pipe 321 is aslant provided. The water supply branch pipe 321 cooperates with the control valve 35 and the water in the water supply pipe 32, so that the water supply assembly 3 is able to transport an object placed in the water supply pipe 32 to a specified position. Specifically, when the green vegetation in the accommodating groove 111 dies, a vegetation seed is wrapped into a ball shape, put into the water supply pipe 32 and transported to the accommodating groove 111 through the water in the water supply pipe 32. In addition, the water supply branch pipe 321 cooperates with the control valve 35, which facilitates the replanting operation of the greening system in the building.

In this embodiment, the water supply branch pipe 321 is provided with a ventilation pipe 322. The ventilation pipe 322 is communicated with external environment. An end of the ventilation pipe 322 that is communicated with the external environment is provided with a medium layer. The medium layer only allows air to circulate and prevents water from passing through. The ventilation pipe 322 provided herein facilitates the communication between the accommodating groove 111 and the external environment. In addition, the ventilation pipe 322 also has a fixing effect on the green vegetation.

Referring to an embodiment shown in FIGS. 1-8, the water supply assembly 3 further includes a rainwater collection assembly 34 communicated with the water supply pipe 32. The rainwater collection assembly 34 provided herein enables the flexible greening system integrated with water into fertilizer in the building to effectively collect and utilize the rainwater, reducing the irrigation cost of the flexible greening system integrated with water into fertilizer.

It should be noted that the rainwater collection assembly 34 includes a water-containing ring, a pipeline communicated with the water-containing ring and the water supply pipe 32 and a box body that is provided on the covering layer 12 and is communicated with the pipeline.

Referring to an embodiment shown in FIGS. 1-11, the flexible greening system integrated with water into fertilizer further includes an intelligent monitoring assembly 4. The intelligent monitoring assembly 4 includes a humidity sensor 41, a precipitation sensor 42 and a controller 43. The humidity sensor 41 is provided in the vegetation growth layer 2 and is configured to monitor a relative humidity in the vegetation growth layer 2. The precipitation sensor 42 is connected to the vegetation fixing assembly 1 or the building and is configured to monitor an external weather condition. The controller 43 is electrically connected to the humidity sensor 41, the precipitation sensor 42 and the water supply assembly 3. The intelligent monitoring assembly 4 is configured to monitor the water content of the vegetation growth layer 2 and weather conditions in real time and transmit them to the controller 43. An operator can control the operation of the water supply assembly 3 through the controller 43, which ensures the efficient use of water resources.

It should be noted that the controller 43 is electrically connected to a control valve and/or an electric valve in the water supply assembly 3.

In this embodiment, the flexible greening system integrated with water into fertilizer further includes a fixing net 5. The fixing net 5 is configured to cover the vegetation growth layer 2 and the green vegetation. The fixing net 5 effectively improves the stability of the green vegetation planted on the vegetation growth layer 2 and avoids property loss or casualties caused by the falling-of of the green vegetation.

In this embodiment, there is no limitation for the number of plies of the fixing net 5 and the height of each ply of the fixing net 5 as long as the fixing net 5 can cover the green vegetation. The fixing net 5 has a certain elasticity, so that it can deform with the growth of the green vegetation, extending the use time of the fixing net 5. A surface of the fixing net 5 is sprayed with an anti-corrosion coating to increase the service life of the fixing net 5.

This application further provides a greening system with an unconventional water source. The greening system with the unconventional water source is provided with the flexible greening system integrated with water into fertilizer mentioned in any of the above embodiments.

Compared to the prior art, the greening system with the unconventional water source is more energy-saving, land-saving, beautiful and environmentally friendly. In addition, the greening system with the unconventional water source provides scientific maintenance and management of the green vegetation and also provides a water-saving and precise irrigation system.

It should be noted that the green vegetation means plants growing on the vegetation growth layer 2.

The above are only preferred embodiments of this application, and are not intended to limit the scope of this application. Any changes and replacements made by those skilled in the art without departing from the spirit and principle of this application shall fall within the scope of this application.

What is claimed is:

1. A flexible greening system integrated with water into fertilizer, comprising:
a vegetation fixing assembly;
a vegetation growth layer; and
a water supply assembly;
wherein the vegetation fixing assembly is configured to connect to a building or to support the flexible greening system; the vegetation growth layer is provided on the vegetation fixing assembly and is configured for planting of green vegetation; the vegetation growth layer comprises a substrate layer for vegetation growth and a drainage layer provided below the substrate layer; the water supply assembly is configured to supply water to the green vegetation; and the water supply assembly is provided with a drainage pipe communicated with the drainage layer.

2. The flexible greening system of claim 1, wherein the vegetation fixing assembly comprises a fixing frame base layer and a covering layer; the fixing frame base layer is configured to connect with the building; the fixing frame base layer is provided with an accommodating groove configured to accommodate the vegetation growth layer; the covering layer is connected to the fixing frame base layer and is configured to cover the accommodating groove; the covering layer is provided with a stem-locking component; and the stem-locking component is configured to enable the green vegetation to pass through and is matched with a stalk of the green vegetation.

3. The flexible greening system of claim 2, wherein the stem-locking component comprises a water-containing ring; the water-containing ring is made of a flexible material and is connected to the covering layer; and the water-containing ring is provided with a water storage cavity communicated with the water supply assembly.

4. The flexible greening system of claim 3, wherein the water-containing ring is communicated with the drainage pipe.

5. The flexible greening system of claim 1, wherein the water supply assembly comprises a water supply pipe and a power pump; the water supply pipe is communicated with a water source for supplying water to the substrate layer; the water supply pipe is communicated with the drainage pipe; and the power pump is communicated with the water supply pipe.

6. The flexible greening system of claim 5, wherein the water supply pipe is provided with a water supply branch pipe configured to be inserted into the vegetation growth layer; the water supply pipe is provided with a control valve; and the control valve is configured to control whether water flows into the water supply branch pipe.

7. The flexible greening system of claim 5, wherein the water supply assembly further comprises a fertilizer tank, a monitoring and control device for monitoring and control of watering and fertilizing and a hydrodynamic fertilizer pump; the fertilizer tank is configured to store a liquid fertilizer; one end of the hydrodynamic fertilizer pump is communicated with the fertilizer tank; and the other end of the hydrodynamic fertilizer pump is communicated with the water supply pipe.

8. The flexible greening system of claim 1, further comprising: a fixing net;
wherein the fixing net is configured to cover the vegetation growth layer and the green vegetation.

9. The flexible greening system of claim 1, further comprising:
an intelligent monitoring assembly;
wherein the intelligent monitoring assembly comprises a humidity sensor, a vegetation growth sensor, a precipitation sensor and a controller; the humidity sensor is provided in the vegetation growth layer and is configured to monitor a relative humidity in the vegetation growth layer; the vegetation growth sensor is provided on the green vegetation and is configured to monitor a growth state of the green vegetation; the precipitation sensor is connected to the vegetation fixing assembly or the building and is configured to monitor an external weather condition; and the controller is electrically connected to the humidity sensor, the vegetation growth sensor, the precipitation sensor and the water supply assembly.
